(19) United States
(12) Patent Application Publication
(10) Pub. No.: US 2019/0122510 A1
(43) Pub. Date: Apr. 25, 2019

(54) SECURITY CONNECTOR

(71) Applicant: InVue Security Products Inc., Charlotte, NC (US)

(72) Inventors: Jonathon D. Phillips, Fort Mill, SC (US); Gary A. Taylor, Fort Mill, SC (US); Christopher J. Fawcett, Charlotte, NC (US)

(21) Appl. No.: 15/743,193

(22) PCT Filed: Jul. 13, 2016
(86) PCT No.: PCT/US2016/041992

§ 371 Date: Jan. 9, 2018

Related U.S. Application Data
(60) Provisional application No. 62/192,289, filed on Jul. 14, 2015.

(51) Int. Cl. G08B 13/14

(52) U.S. Cl. CPC G08B 13/1409; H01R 13/642

(57) ABSTRACT

In one example, a connector for providing security to an article of merchandise is provided, wherein the article of merchandise includes an input port and internal circuitry. The connector includes a connection portion configured to releasably engage the input port of the article of merchandise. The connector also includes at least one pair of ground conductors configured to cooperate with the internal circuitry of the article of merchandise to define a sense loop when the connector is engaged with the article of merchandise. Interruption of the sense loop is indicative of a security event.

### CROSS REFERENCE TO RELATED APPLICATION

This application claims the benefit of priority to U.S. Provisional Application No. 62/192,289 filed on Jul. 14, 2015, the entire disclosure of which is incorporated herein by reference.

### FIELD OF THE INVENTION

Embodiments of the present invention relate generally to connectors for electronic devices, including connectors for securing electronic devices from theft.

### BACKGROUND OF THE INVENTION

Retailers routinely display articles of merchandise, such as portable computers (e.g. notebooks, laptops, tablets, etc.), mobile phones, e-readers, media players, and the like for customers to evaluate before making a purchase. These articles of merchandise are continually being made smaller and lighter in weight due to advances in technology and materials. As a result, such merchandise is increasingly vulnerable and susceptible to theft. At the same time, the retail price and profit margin for such merchandise continues to decline. Accordingly, these articles of merchandise need to be secured by a security device that effectively and cost efficiently protects the merchandise from theft.

It is common in the retail security industry to have electronic devices tethered to a store fixture to prevent theft yet allow a customer to interact with the device. In addition, it is desirable to provide power to the electronic device so that the device may be charged and operable for use by a potential customer. Therefore, there is a need for improved connectors that are capable of providing both power and security to the electronic device without affecting the existing functionality of the connector.

### BRIEF SUMMARY

Embodiments of the present invention are directed towards connectors, security systems, and methods for providing security to an article of merchandise. In one embodiment, a connector includes a connection portion configured to operably engage a cord and configured to releasably engage an input port of the article of merchandise. The connector also includes at least one pair of ground conductors configured to cooperate with internal circuitry of the article of merchandise to define a sense loop when the connector is engaged with the article of merchandise. Interruption of the sense loop is indicative of a security event.

In another embodiment, a security system includes a controller and a cord configured to operably engage the controller. The security system also comprises a connector operably engaged with a cord and configured to releasably engage the input port of the article of merchandise. The connector further includes a plurality of conductors, at least one pair of the conductors being ground conductors. The at least one pair of ground conductors are configured to cooperate with the internal circuitry of the article of merchandise to define a sense loop when the connector is engaged with the article of merchandise. In addition, the at least one pair of ground conductors are configured to transmit a signal when the connector is engaged with the article of merchandise, and the controller is configured to detect a change in the signal that is indicative of a security event.

In one embodiment, a method includes engaging a connector to an article of merchandise for providing power and security signals therebetween. The connector includes a plurality of conductors, at least one pair of the conductors being ground conductors configured to cooperate with the internal circuitry of the article of merchandise to define a sense loop when the connector is engaged with the article of merchandise.

In another embodiment, a method includes transmitting power and security signals through a connector engaged with an article of merchandise. The connector includes a plurality of conductors, at least one pair of the conductors being ground conductors configured to cooperate with the internal circuitry of the article of merchandise to define a sense loop when the connector is engaged with the article of merchandise. The method further includes detecting an interruption in the sense loop that is indicative of a security event.

### BRIEF DESCRIPTION OF THE DRAWINGS

FIG. 1 is a schematic of a security system according to one embodiment of the present invention.

FIG. 2 is a perspective view of a connector according to one embodiment of the present invention.

FIG. 3 is a plan view of a conductive shield according to one embodiment of the present invention.

FIG. 4 is a schematic of a security system according to one embodiment of the present invention.

### DETAILED DESCRIPTION OF EMBODIMENTS OF THE INVENTION

Embodiments of the present invention will now be described more fully hereinafter with reference to the accompanying drawings, in which exemplary embodiments of the invention are shown. This invention may, however, be embodied in many different forms and should not be construed as limited to the embodiments set forth herein. Rather, the exemplary embodiments are provided so that this disclosure will be thorough and complete, and will fully convey the scope of the invention to those skilled in the art.

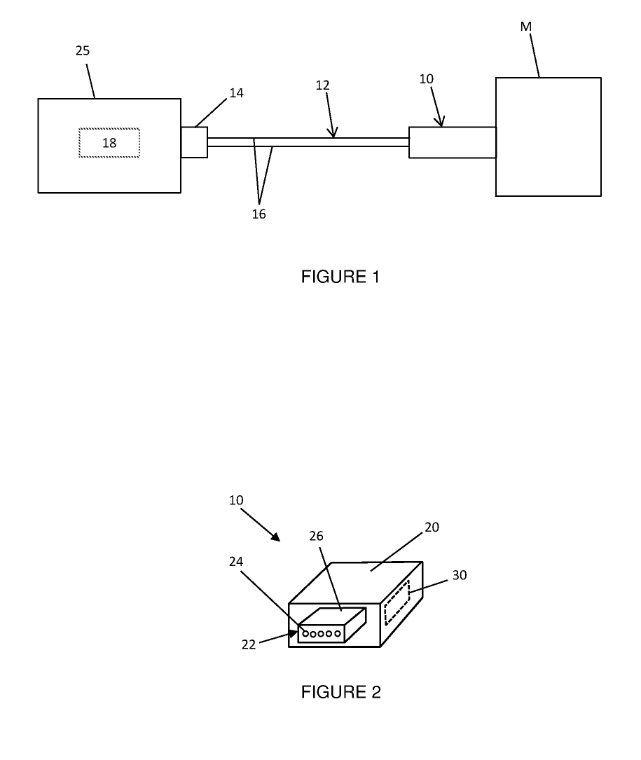

Reference will now be made to the accompanying drawing figures wherein identical reference numerals denote the same or similar elements throughout the various views. One or more embodiments of a connector 10 for securing an article of merchandise “M” from theft are described below. The article of merchandise M may be a display model or an operational sample of electronic merchandise, such as portable computers (e.g. notebooks, laptops, tablets, etc.), e-readers, mobile phones, smart phones, media players, and the like, for a customer to examine before making a decision to purchase the item. The article of merchandise M may be typically displayed in a manner that permits a prospective purchaser to evaluate the operation and features of the merchandise, while protecting the merchandise from a potential thief. A power cord or tether 12 may be operably engaged with the article of merchandise M at one end, and according to one embodiment, a security event (e.g., removal, cutting, or tampering of the power cord) may result in the generation of a security signal (e.g., an audible and/or visual alarm). For example, the power cord 12 may be operably engaged with an alarm device 25 configured to generate a security signal upon detecting a security event. In one embodiment, the power cord 12 includes a connector 14 configured to operably engage an alarm device 25 (see, e.g., FIG. 1).

Embodiments of the present invention provide for the delivery of at least power to the article of merchandise M on display through a power cord, cable, or the like. The power cord 12 may include a plurality of conductors 16. For example, a pair of conductors 16 in the power cord 12 (e.g., a positive power line and a ground line) may provide power to the article of merchandise M. An input power source or controller 18 may be in electrical communication with the power cord for transmitting power and other signals through the cord 12 and to the article of merchandise M. The power cord 12 may include additional conductors 16 if desired, such as for transmitting data, audio, video, optical and/or communication signals. Moreover, in one embodiment, the power cord 12 includes at least one conductor 16 for transmitting a security signal. For example, the power cord 12 may include a plurality of conductors 16, one of which for transmitting a signal to the connector 10, and a second conductor for returning the signal back through the power cord. Should the signal be disrupted (e.g., the cord 12 is removed or cut), a security signal may be generated. For instance, an audible and/or a visible signal may be generated. In addition, the functionality of the article of merchandise M may be interrupted and locked from further use without being overridden by an authorized user, such as by inputting a passcode or using an appropriate key.

One end of the power cord 12 includes a connector 10 configured to electrically couple to the article of merchandise M. The opposite end of the power cord is configured to be coupled to a power source 18, such as a USB-port on another electronic device or an electrical outlet. Thus, the power cord 12 may include a USB connector or the like that is electrically connected to the connector 10 at the opposite end of the cord. In other embodiments, the power cord 12 may be electrically coupled to an alarm device 25 and/or sensor, as explained in further detail below. The connector 10 is configured to provide at least power and security signals to the article of merchandise.

Generally, the connector 10 may include a body portion 20 and a connection portion 22 extending outwardly therefrom (see, e.g., FIG. 2). The body portion 20 and connection portion 22 may be separate members coupled to one another or integrally formed as a single component. Although the body portion 20 and the connection 22 portion may be various sizes and configurations, the connection portion is illustrated as having a smaller cross-sectional dimension than the body portion. The power cord 12 is coupled to the body portion 20, while the connection portion 22 is configured to be inserted within an input port of the article of merchandise M so as to be electrically connected thereto. The body portion 20 may be hard wired to the power cord 12 or connected using a suitable releasable coupling.

The connection portion 22 comprises a plurality of conductors 24, contacts, or pins that correspond to the conductors 16 in the power cord, as discussed above. The connection portion 22 may include any number of conductors 24, such as 2, 4, 6, 8, 10, 12, 24, etc. The conductors 24 may be positioned within a conductive shield 26. Thus, the shield 26 may surround the conductors 24 and form an outer surface of the connection portion 22. The shield 26 may include one or more engagement features that facilitate engagement with corresponding engagement features in the input port 15 of the article of merchandise M. In one embodiment, the conductive shield 26 is a conductive metal material.

The input port 15 of the article of merchandise M may include a plurality of conductors, pins, or contacts that are configured to electrically connect to corresponding conductors 24 on the connection portion 22 and/or conductive shield 26 when the connection portion is engaged with the input port (see, e.g., FIG. 4). In one embodiment, the input port 15 includes a plurality of conductors that are configured to electrically connect to the conductors 24 and/or the conductive shield 26 of the connector. The article of merchandise M also includes internal circuitry 17, such as a printed circuit board or the like, that is electrically connected to the input port.

The cable 14, shield 26, and/or body portion 20 may house a processor 30 for communicating with the article of merchandise M. The processor 30 may be configured to perform a variety of functions, such as authenticating that the connector is compatible with the article of merchandise. The processor 30 could also be configured to detect the orientation of the connector 10. In this regard, the connector 10 may be bi-directional in that the connector may be inserted into an input port of the article of merchandise M in a first orientation and a second opposite orientation, which is unlike conventional USB-A and micro-USB connectors. For example, the connector 10 may be inserted in orientations 180 degrees opposite from one another. The processor 30 may, in turn, detect the orientation of the connector so that the electrical signals may be routed to the proper conductors in the connection portion. Moreover, the processor may be configured to determine the power or voltage requirements of the article of merchandise M so that the appropriate voltage may be delivered to the article.

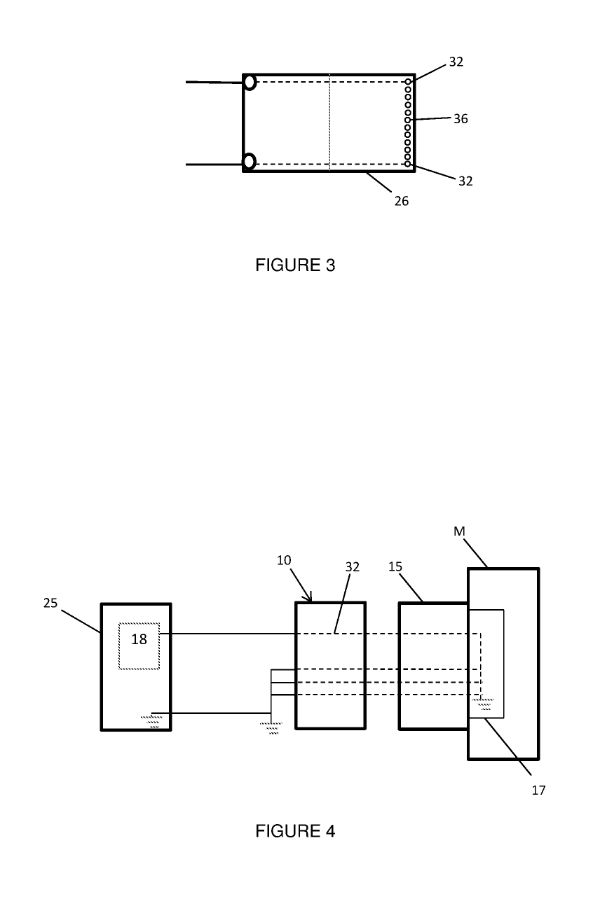

The connector 10 is further configured to facilitate detection of a security event, such as removal or cutting of the power cord 12. In this regard, FIG. 3 shows an embodiment of a connector 10 that includes at least one pair of ground conductors 32 that are not electrically connected to one another or the shield 26 when the connector is not connected to the article of merchandise M. When the connector 10 is inserted within the input port 15 of the article of merchandise M, the ground conductors 32 become electrically connected to the internal circuitry 17 of the article of merchandise M due to interaction with the conductors of the input port, thereby completing an electrical circuit. In other words, the internal circuitry 17 of the article of merchandise M is shorted to the ground conductors 32. As noted above, the power cord 12 may include a plurality of conductors 16, one of which is for transmitting a signal to the connector 10 (e.g., via a first ground conductor), and at least a second ground conductor for returning the signal back through the power cord. As long as the connector 10 is electrically connected to the article of merchandise M, the sense loop through the ground conductors 32 and the internal circuitry 17 are uninterrupted. Should the sense loop be disrupted (e.g., the cord 12 is removed or cut), a security signal may be generated. Thus, as soon as the connector 10 is removed from the article of merchandise M, the shorted conductors would open or otherwise lose electrical connectivity, resulting in the generation of a security signal. FIG. 3 also shows that the connector 10 includes a conductor 36 that allows power to be provided to the connector, which may be used to provide power to the article of merchandise M. Thus, the article of merchandise M may be charged via the connector 10.

FIG. 4 shows an example where the connector 10 includes four ground conductors 32. One of the ground conductors 32 may be configured to transmit a security signal generated by the controller 18. The remaining ground conductors 32 may be tied together to the same common ground, which may also be tied to ground in the alarm device 25. Prior to insertion within the input port 15, the ground conductors 32 are not electrically connected to one another. However, when inserted within the input port 15, each ground conductor 32 is shorted to the ground via the internal circuitry 17 within the article of merchandise via a common ground. Thus, a sense loop is configured to be defined via the ground conductors 32 between the alarm device 25 and the article of merchandise M.

In one particular example, the connector is a USB type-C connector. Thus, the connector may include two or more pairs of ground conductors. The USB type-C connector may have the configuration described in Universal Serial Bus Type-C Cable and Connector Specification, Revision 1.1, Apr. 3, 2015. The USB-type C connector may cooperate with USB type-C cables for power and data transfer, including those that function using the Universal Serial Bus Power Delivery Specification, Revision 2.0, Aug. 11, 2014. In addition, the USB type-C connector may operate using various USB standards, including USB 2.0, 3.0, and 3.1.

In some embodiments, the power cord 12 is coupled to an alarm device 25 and/or sensor. For instance, the power cord 12 may electrically connect an alarm device 25 and/or sensor to the article of merchandise M. Thus, upon the occurrence of a security event, the alarm device 25 may include circuitry for detecting the security event and generating an appropriate security signal. For example, the alarm device 25 may be similar to those manufactured by InVue Security Products Inc. For example, the alarm device may include a display module, base, stand, or mounting member configured to removably support the article of merchandise M, as well as provide power and security to the article of merchandise. According to some embodiments, the alarm device may be similar to those disclosed in U.S. Pat. No. 7,710,266, entitled Security System with Product Power Capability and issued May 4, 2010, and U.S. Pat. No. 7,727,843, entitled Programmable Alarm Module and System for Protecting Merchandise and issued Jun. 15, 2010, each of which is incorporated by reference herein in its entirety. Moreover, the alarm device 25 could be integrated with an input power source or controller 18, such as for providing and/or receiving power and/or security signals from the connector 10 and/or the article of merchandise M.

In another embodiment of the present invention, a connector 10 is configured to interact with the article of merchandise M to define a sense loop and detect any interruptions in the sense loop indicative of a security event. The existing structure of the connector 10 may be used in this manner without the need to modify the existing conductor arrangement. For example, when the connector 10 is engaged with the article of merchandise M, the article of merchandise may communicate with the connector on one or more data conductors to establish communication therebetween. Thus, the output of the article of merchandise M may be used to determine that the article of merchandise is present and connected to the connector 10.

In other embodiments, a power out conductor of the connector 10 may be used to determine whether a security event has occurred. For instance, a sensor coupled to the connector 10 may be configured to receive power from the article of merchandise M (e.g., via USB-On-the-Go), and one or more conductors of the connector may be configured to transfer power out to the sensor. Thus, as long as the sensor is receiving power from the article of merchandise, the sense loop is complete. However, where the connector 10 is removed from the article of merchandise M or the sense loop is otherwise interrupted, the power being transferred out will cease, which will be detectable as a security event.

In an additional embodiment, the power requirements of the article of merchandise M may be used to determine whether a security event occurs. For example, a processor associated with the connector 10 and/or cable 12 may be configured to request the power requirements of the article of merchandise M. The negotiation of the power requirement may be used to determine that the connector 10 is engaged and in communication with the article of merchandise M.

Embodiments of the present invention provide advantages over similar connectors that may otherwise be incapable of providing security to the article of merchandise. This functionality is advantageous in a retail environment where articles of merchandise are on display for inspection by a customer.

The foregoing has described one or more embodiments of a connector for securing an article of merchandise from theft. Those of ordinary skill in the art will understand and appreciate that numerous variations and modifications of the invention may be made without departing from the spirit and scope of the invention. Accordingly, all such variations and modifications are intended to be encompassed by the appended claims.

1. A connector for providing security to an article of merchandise, the article of merchandise comprising an input port and internal circuitry, the connector comprising:
a connection portion configured to be operably engaged with a cord and configured to releasably engage the input port of the article of merchandise; and
a plurality of conductors, at least one pair of the conductors being ground conductors,
wherein the pair of ground conductors are configured to cooperate with the internal circuitry of the article of merchandise to define a sense loop when the connector is engaged with the article of merchandise, and
wherein interruption of the sense loop is indicative of a security event.

2. The connector according to claim 1, wherein at least a pair of the plurality of conductors are configured to transmit power between the connector and the article of merchandise.

3. (canceled)

4. The connector according to claim 1, wherein the connection portion comprises a conductive shield.

5. The connector according to claim 4, wherein the at least one pair of ground conductors are not shorted to the conductive shield.

6. The connector according to claim 4, wherein the conductive shield houses and surrounds the pair of ground conductors.

7. The connector according to claim 1, wherein the connection portion is configured to electrically connect to the article of merchandise in different orientations.

8. The connector according to claim 1, wherein the plurality of conductors comprise two pairs of ground conductors.

9. The connector according to claim 8, wherein one of the ground conductors is configured to transmit a security signal, and wherein the remaining ground conductors are tied to a common ground.

10. The connector according to claim 1, wherein the plurality of conductors are configured to transmit data between the connector and the article of merchandise.

11. (canceled)

12. The connector according to claim 1, further comprising a body portion configured to be connected to a cord, wherein the connection portion is engaged with the body portion.

13. A security system for providing security to an article of merchandise, the article of merchandise comprising an input port and internal circuitry, the security system comprising:
a controller;
a cord configured to operably engage the controller; and
a connector operably engaged with the cord and configured to releasably engage the input port of the article of merchandise, the connector comprising a plurality of conductors, at least one pair of the conductors being ground conductors,
wherein the at least one pair of ground conductors are configured to cooperate with the internal circuitry of the article of merchandise to define a sense loop when the connector is engaged with the article of merchandise,
wherein the at least one pair of ground conductors are configured to transmit a signal when the connector is engaged with the article of merchandise, and
wherein the controller is configured to detect a change in the signal that is indicative of a security event.

14. The security system according to claim 13, wherein the connector is a USB Type-C connector.

15. The security system according to claim 13, wherein the connector comprises a conductive shield, and wherein the conductive shield surrounds the pair of ground conductors.

16. The security system according to claim 15, wherein the at least one pair of ground conductors are not shorted to the conductive shield.

17. (canceled)

18. The security system according to claim 13, wherein the connector is configured to electrically connect to the article of merchandise in different orientations.

19. The security system according to claim 13, wherein the plurality of conductors comprise two pairs of ground conductors.

20. The security system according to claim 19, wherein one of the ground conductors is configured to transmit a security signal, and wherein the remaining ground conductors are tied to a common ground.

21. The security system according to claim 13, wherein the plurality of conductors are configured to transmit data between the connector and the article of merchandise.

22. (canceled)

23. A method for securing an article of merchandise comprising:
transmitting power and security signals through a connector engaged with an article of merchandise, the connector comprising a plurality of conductors, at least one pair of the conductors being ground conductors configured to cooperate with the internal circuitry of the article of merchandise to define a sense loop when the connector is engaged with the article of merchandise; and
detecting an interruption in the sense loop that is indicative of a security event.
